(19) United States
(12) Patent Application Publication
(10) Pub. No.: US 2014/0315495 A1
(43) Pub. Date: Oct. 23, 2014

(54) Systems and Methods for Predictive Radio-Frequency Testing of Electronic Devices

(71) Applicant: APPLE INC., Cupertino, CA (US)

(72) Inventors: Brian C. Joseph, San Jose, CA (US); Song Liu, Dublin, CA (US)

(73) Assignee: Apple Inc., Cupertino, CA (US)

(21) Appl. No.: 13/868,508

(22) Filed: Apr. 23, 2013

(51) Int. Cl. H04W 24/08

(52) U.S. Cl. CPC H04W 24/08
USPC 455/67.11

(57) ABSTRACT

A test system may test the radio-frequency (RF) performance of wireless electronic devices under test (DUTs). The RF performance of the DUTs may be characterized by a set of performance metrics. The test system may obtain correlation information for each performance metric in the set of performance metrics. The correlation information may identify predictor performance metrics and associated dependent performance metrics in the set of performance metrics. The test system may gather measurement data from a selected DUT by measuring the predictor performance metrics on the selected DUT. The production test station may generate a conditional probability distribution for the dependent performance metric given the measurement data and the correlation information. The production test station may determine whether to omit testing of the dependent performance metric for the selected DUT by comparing an area under the conditional probability distribution for the dependent performance metric to a predetermined threshold.

### BACKGROUND

This relates generally to electronic devices, and more particularly, to electronic devices having wireless communications circuitry.

Wireless electronic devices such as portable computers and cellular telephones are often provided with wireless communications circuitry. The wireless communications circuitry is tested in a test system having a number of test stations to ensure adequate radio-frequency performance. The test system characterizes the radio-frequency performance of wireless communications circuitry in a group of wireless electronic devices under test using a fixed set of radio-frequency performance metrics.

During conventional testing operations, the test system tests each performance metric in the fixed set of performance metrics on each wireless electronic device under test. Performing test operations in this way may be time consuming and may lead to high manufacturing costs.

It would therefore be desirable to be able to provide improved test systems for testing wireless electronic devices.

### SUMMARY

A wireless electronic device may include wireless communications circuitry. The wireless communications circuitry may include baseband circuitry, radio-frequency transceiver circuitry, and antenna structures. The wireless communications circuitry may transmit and receive radio-frequency signals.

A test system may be used to perform radio-frequency testing on a wireless electronic device to determine whether the wireless electronic device has adequate radio-frequency performance. Radio-frequency signals may be conveyed between the test system and wireless electronic devices under test (DUTs).

The test system may perform pass-fail tests on a number of DUTs to determine whether the DUTs perform satisfactorily. The test system may evaluate device performance for the DUTs by measuring a set of performance metrics associated with signal transmission and reception by the DUTs. The test system may analyze the set of performance metrics to predict which of the performance metrics are redundant for performing pass-fail tests on the DUTs. For example, the test system may determine which of the performance metrics exhibit probabilities of failure that are less than a predetermined threshold. If a DUT has a probability of failing testing for a given performance metric that is less than the predetermined threshold, that performance metric may be labeled a “redundant” performance metric and the test system may omit testing for that performance metric.

The test system may include a sentinel test station and a number of production test stations. The sentinel test station may gather performance metric data from a group of DUTs by measuring a set of performance metrics for the group of DUTs. The sentinel test station may obtain correlation information for each performance metric in the set of performance metrics. The correlation information may, for example, include correlation coefficients and covariance values for each respective pair of performance metrics in the set of performance metrics.

If desired, the sentinel test station may perform radio-frequency testing on each performance metric in the set of performance metrics while production test stations may omit certain performance metrics from testing. One or more production test stations may, if desired, periodically operate in a sentinel test station mode to generate correlation information from the group of DUTs.

The correlation information may identify predictor performance metrics and associated dependent performance metrics in the set of performance metrics. The predictor performance metrics may be used to predict the probability that the DUTs will pass testing for the associated dependent performance metrics (e.g., without performing testing for the dependent performance metrics). The sentinel test station may pass the correlation information to each production test station in the test system.

A production test station may gather measurement data from a selected DUT (e.g., a DUT selected from a group of DUTs that has not been tested by the sentinel test station) by measuring a subset of the set of performance metrics (e.g., by measuring predictor performance metrics for the selected DUT). The production test station may determine whether to omit testing of a dependent performance metric associated with the subset of performance metrics based on the correlation information and the measurement data.

For example, the production test station may generate a conditional probability distribution for the dependent performance metric given the measurement data and the correlation information (e.g., a multivariate normal conditional probability distribution). The production test station may compare an area under the conditional probability distribution to a predetermined threshold. If the area under the conditional probability distribution is greater than the predetermined threshold, the production test station may perform testing of the dependent performance metric for the selected DUT. If the area under the conditional probability distribution is less than the predetermined threshold, the production test station may perform outlier detection operations for the gathered measurement data.

For example, the production test station may compare the gathered measurement data to outlier thresholds to determine whether the gathered measurement data includes outlier measurement values. If no outlier measurement values are identified in the measurement data, the production test station may omit testing for the dependent performance metric on the selected DUT. If an outlier measurement value is identified in the measurement data, the production test station may perform testing of the dependent metric for the selected DUT.

Further features of the present invention, its nature and various advantages will be more apparent from the accompanying drawings and the following detailed description.

### BRIEF DESCRIPTION OF THE DRAWINGS

FIG. 1 is a schematic diagram of an illustrative wireless electronic device having wireless communications circuitry in accordance with an embodiment of the present invention.

FIG. 2 is a diagram of an illustrative test system having sentinel and production test stations for performing predictive radio-frequency testing on wireless electronic devices in accordance with an embodiment of the present invention.

FIG. 3 is a graph showing how a first performance metric measured by a test station may be a well-correlated with a second performance metric in accordance with an embodiment of the present invention.

FIG. 4 is a graph showing how different performance metrics measured by a test station may be uncorrelated in accordance with an embodiment of the present invention.

FIG. 5 is a flow chart of illustrative steps that may be performed by a test system of the type shown in FIG. 2 to provide radio-frequency testing for a wireless electronic device while omitting testing for redundant performance metrics in accordance with an embodiment of the present invention.

FIG. 6 is a graph showing how different values of a predictor performance metric may be measured by a test station from a group of wireless electronic devices under test for generating performance metric correlation information in accordance with an embodiment of the present invention.

FIG. 7 is a graph showing how different values of a dependent performance metric may be measured by a test station from a group of wireless electronic devices under test for generating performance metric correlation information in accordance with an embodiment of the present invention.

FIG. 8 is a flow chart of illustrative steps that may be performed by a production test station of the type shown in FIG. 2 to determine whether to omit testing of dependent performance metrics for a wireless electronic device under test in accordance with an embodiment of the present invention.

FIG. 9 is a graph showing how a conditional probability distribution for a dependent performance metric may be compared to radio-frequency thresholds to determine the probability that a wireless electronic device under test will fail testing for the dependent performance metric in accordance with an embodiment of the present invention.

FIG. 10 is a graph showing how a production test station may compare a measured value of a predictor performance metric to outlier thresholds for determining whether to omit testing for a corresponding dependent performance metric in accordance with an embodiment of the present invention.

FIG. 11 is a graph showing how a wireless electronic device under test may have different adjacent channel leakage ratios that are well-correlated for signals transmitted at different frequencies in accordance with an embodiment of the present invention.

FIG. 12 is a flow chart of illustrative steps that may be performed by a production test station of the type shown in FIG. 2 to determine whether to omit radio-frequency testing for any desired combination of performance metrics on a wireless electronic device under test in accordance with an embodiment of the present invention.

FIG. 13 is a flow chart of illustrative steps that may be performed by a production test station of the type shown in FIG. 2 to periodically gather correlation information from a group of wireless electronic devices under test in accordance with an embodiment of the present invention.

### DETAILED DESCRIPTION

This relates generally to wireless communications, and more particularly, to systems and methods for testing wireless communications circuitry.

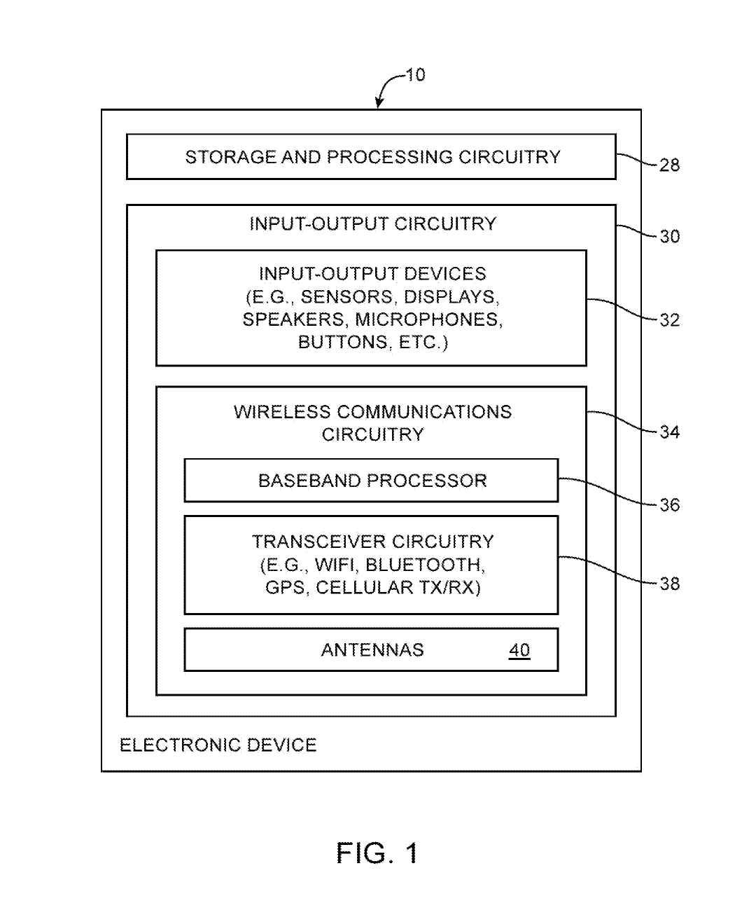

Electronic devices such as device 10 of FIG. 1 may be provided with wireless communications circuitry. The wireless communications circuitry may be used to support long-range wireless communications such as communications in cellular telephone bands. Examples of long-range (cellular telephone) bands that may be handled by device 10 include the 800 MHz band, the 850 MHz band, the 900 MHz band, the 1800 MHz band, the 1900 MHz band, the 2100 MHz band, the 700 MHz band, and other bands. The long-range bands used by device 10 may include the so-called LTE (Long Term Evolution) bands. The LTE bands are numbered (e.g., 1, 2, 3, etc.) and are sometimes referred to as E-UTRA operating bands.

Long-range signals such as signals associated with satellite navigation bands may be received by the wireless communications circuitry of device 10. For example, device 10 may use wireless circuitry to receive signals in the 1575 MHz band associated with Global Positioning System (GPS) communications, in the 1602 MHz band associated with Global Navigation Satellite System (GLONASS) communications, etc. Short-range wireless communications may also be supported by the wireless circuitry of device 10. For example, device 10 may include wireless circuitry for handling local area network links such as WiFi® links at 2.4 GHz and 5 GHz, Bluetooth® links at 2.4 GHz, etc. In general, wireless communications circuitry in device 10 may support wireless communications in any suitable communications bands.

As shown in FIG. 1, device 10 may include storage and processing circuitry 28. Storage and processing circuitry 28 may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in storage and processing circuitry 28 may be used to control the operation of device 10. This processing circuitry may be based on one or more microprocessors, microcontrollers, digital signal processors, application specific integrated circuits, etc.

Storage and processing circuitry 28 may be used to run software on device 10, such as internet browsing applications, voice-over-internet-protocol (VOIP) telephone call applications, email applications, media playback applications, operating system functions, functions related to communications band selection during radio-frequency transmission and reception operations, software for testing the radio-frequency performance of device 10, etc. To support interactions with external equipment (e.g., a radio-frequency base station, radio-frequency test equipment, etc.), storage and processing circuitry 28 may be used in implementing communications protocols.

Communications protocols that may be implemented using storage and processing circuitry 28 include internet protocols, wireless local area network protocols (e.g., IEEE 802.11 protocols—sometimes referred to as WiFi®), protocols for other short-range wireless communications links such as the Bluetooth® protocol, IEEE 802.16 (WiMax) protocols, cellular telephone protocols such as the “2G” Global System for Mobile Communications (GSM) protocol, the “2G” Code Division Multiple Access (CDMA) protocol, the “3G” Universal Mobile Telecommunications System (UMTS) protocol, the “3G” Evolution-Data Optimized (EV-DO) protocol, the “4G” Long Term Evolution (LTE) protocol, MIMO (multiple input multiple output) protocols, antenna diversity protocols, etc.

Input-output circuitry 30 may include input-output devices 32. Input-output devices 32 may be used to allow data to be supplied to device 10 and to allow data to be provided from device 10 to external devices. Input-output devices 32 may include user interface devices, data port devices, and other input-output components. For example, input-output devices may include touch screens, displays without touch sensor capabilities, buttons, joysticks, click wheels, scrolling wheels, touch pads, key pads, keyboards, microphones, cameras, buttons, speakers, status indicators, light sources, audio jacks and other audio port components, digital data port devices, light sensors, motion sensors (accelerometers), capacitance sensors, proximity sensors, etc.

Input-output circuitry 30 may include wireless communications circuitry 34 for communicating wirelessly with external equipment (e.g., a radio-frequency base station, radio-frequency test equipment, etc.). Wireless communications circuitry 34 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Wireless communications circuitry 34 may include radio-frequency transceiver circuitry 38 for handling various radio-frequency communications bands. For example, circuitry 38 may handle the 2.4 GHz and 5 GHz communications bands for WiFi® (IEEE 802.11) communications, the 2.4 GHz communications band for Bluetooth® communications, cellular telephone bands such as at 850 MHz, 900 MHz, 1800 MHz, 1900 MHz, and 2100 MHz and/or the LTE bands and other bands (as examples). Circuitry 38 may handle voice data and non-voice data traffic. Transceiver circuitry 38 may include global positioning system (GPS) receiver equipment for receiving GPS signals at 1575 MHz or for handling other satellite positioning data.

Wireless communications circuitry 34 may include one or more antennas 40. Antennas 40 may be formed using any suitable antenna types. For example, antennas 40 may include antennas with resonating elements that are formed from loop antenna structures, patch antenna structures, inverted-F antenna structures, slot antenna structures, planar inverted-F antenna structures, monopole antenna structures, dipole antenna structures, helical antenna structures, hybrids of these designs, etc. Different types of antennas may be used for different bands and combinations of bands. For example, one type of antenna may be used in forming a Wi-Fi® wireless link antenna and another type of antenna may be used in forming a cellular wireless link antenna. During communication operations, transceiver circuitry 38 may be used to transmit radio-frequency signals at desired frequencies via antennas 40 (e.g., antennas 40 may transmit wireless signals having a desired frequency).

As shown in FIG. 1, wireless communications circuitry 34 may also include baseband processor 36. Baseband processor 36 may include memory and processing circuits and may also be considered to form part of storage and processing circuitry 28 of device 10.

The radio-frequency performance of wireless communications circuitry 34 in device 10 may be characterized by one or more wireless performance metrics. Device 10 may generate data associated with wireless performance metrics in response to received (downlink) signals (sometimes referred to herein as downlink performance metric data). For example, device 10 may generate downlink performance metric data associated with performance metrics such as received power, receiver sensitivity, frame error rate, bit error rate, channel quality measurements based on received signal strength indicator (RSSI) information, adjacent channel leakage ratio (ACLR) information (e.g., ACLR information in one or more downlink frequency channels), channel quality measurements based on received signal code power (RSCP) information, channel quality measurements based on reference symbol received power (RSRP) information, channel quality measurements based on signal-to-interference ratio (SINR) and signal-to-noise ratio (SNR) information, channel quality measurements based on signal quality data such as Ec/Io or Ec/No data, information on whether responses (acknowledgements) are being received from a cellular telephone tower corresponding to requests from the electronic device, information on whether a network access procedure has succeeded, information about how many re-transmissions are being requested over a cellular link between the electronic device and a cellular tower, information on whether a loss of signaling message has been received, information on whether paging signals have been successfully received, any desired combination of these performance metrics, and other information that is reflective of the performance of wireless circuitry 34 in device 10. Downlink performance metric data may, for example, include downlink performance metric values measured for a given performance metric (e.g., measured error rate values, measured SNR values, measured RSSI values, etc.).

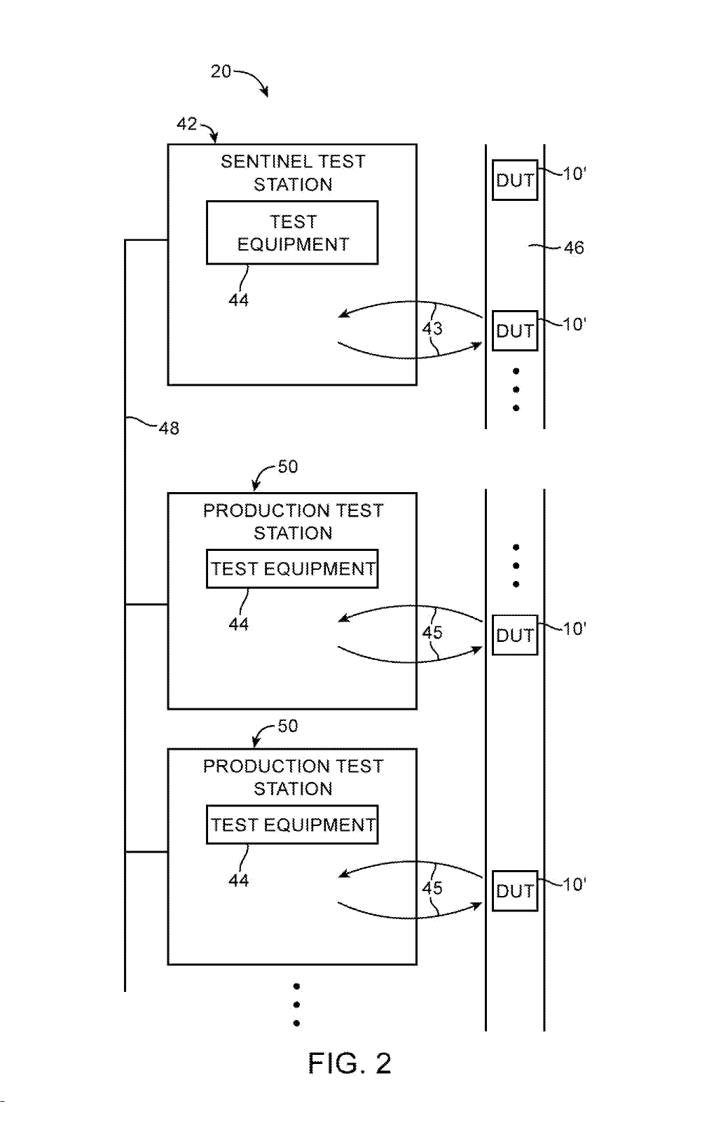

One or more radio-frequency test stations may be provided for performing radio-frequency tests (e.g., radio-frequency pass-fail test operations) on wireless communications circuitry in electronic devices such as device 10 (e.g., to ensure adequate radio-frequency performance of wireless communications circuitry 34 during manufacture of device 10). The radio-frequency performance of multiple wireless electronic devices 10 may be tested using a test system such as test system 20 of FIG. 2

Each electronic device that is being tested using test system 20 may sometimes be referred to as device under test (DUT) 10′. DUT 10′ may be, for example, a fully assembled electronic device such as electronic device 10 or a partially assembled electronic device (e.g., DUT 10′ may include some or all of wireless circuitry 34 prior to completion of manufacturing). It may be desirable to test wireless communications circuitry 34 within partially assembled electronic devices so that wireless communications circuitry 34 can be more readily accessed during test operations (e.g., to test the performance of wireless communications circuitry 34 that has not yet been enclosed within a device housing).

As shown in FIG. 2, test system 20 may include radio-frequency test stations such as sentinel test station 42 and a number of production test stations 50 arranged along a conveying structure such as conveyor belt 46 (e.g., a belt that moves in direction 52) so that multiple DUTS 10′ can be tested in parallel. Sentinel test station 42 may perform radio-frequency testing on a group of DUTs 10′ prior to testing DUTs 10′ with production test stations 50. The example of FIG. 2 is merely illustrative. If desired, any conveying structure may be used that allows testing of multiple DUTs 10′ in parallel (e.g., a robotic loading system, a manual loading system, etc.). Test system 20 may include any desired number of sentinel test stations 42 and production test stations 50 for testing DUTs 10′.

During test operations, each DUT in a group of DUTs 10′ may be individually tested by sentinel test station (see, e.g., arrows 43). An additional group of DUTs 10′ may be passed to production test stations 50 (e.g., the additional group of DUTs 10′ may be different from the group of DUTs 10′ tested by sentinel test station 42). DUTs 10′ may each be tested by production test stations 50 in parallel (see, e.g., arrows 45). Sentinel test station 42 may supply test information (e.g., radio-frequency test results, performance metric correlation information, test instructions, etc.) to production test stations 50 over line 48. In another suitable arrangement, sentinel test station 42 may be coupled to production test stations 50 via a wireless “over-the-air” connection.

Sentinel test station 42 and production test stations 50 may each include test equipment 44 for performing radio-frequency test operations on DUTs 10′. Test equipment 44 may, for example, include a test host (e.g., a personal computer, laptop computer, handheld computing device, etc.) and a radio-frequency tester (e.g., a radio communications analyzer, spectrum analyzer, signal generator, power sensor, vector network analyzer, etc.). Test equipment 44 may include storage circuitry. Storage circuitry in test equipment 44 may include one or more different types of storage such as hard disk drive storage, nonvolatile memory (e.g., flash memory or other electrically-programmable-read-only memory), volatile memory (e.g., static or dynamic random-access-memory), etc.

During radio-frequency test operations, radio-frequency test signals may be transmitted between DUTs 10′ and test equipment 44. For example, radio-frequency uplink test signals may be transmitted from DUTs 10′ and received by test equipment 44, whereas radio-frequency downlink test signals may be transmitted from test equipment 44 and received by DUTs 10′. Test signals transmitted between DUTs 10′ and test equipment 44 may, if desired, be transmitted at selected frequencies using desired communications protocols, modulation schemes, signal power levels, etc.

During radio-frequency test operations, DUT 10′ may obtain radio-frequency downlink performance metric data in response to downlink test signals received from test equipment 44. For example, DUT 10′ may gather SNR values, RSSI values, receiver sensitivity values, or any other desired information associated with the radio-frequency performance of wireless communications circuitry 34 in response to receiving downlink radio-frequency signals. Test equipment 44 may subsequently gather downlink performance metric data from DUT 10′ for processing.

Test equipment 44 may obtain radio-frequency performance metric data in response to uplink test signals received from DUT 10′ (sometimes referred to herein as uplink performance metric data). For example, test equipment 44 may gather data associated with Error Vector Magnitude (EVM), output power, spectral parameters, Adjacent Channel Leakage Ratio (ACLR), or any other desired performance metric associated with uplink signal transmission by DUT 10′. Uplink performance metric data may be used to characterize the radio-frequency performance of DUT 10′ while transmitting signals.

Uplink and downlink performance metric data gathered by test equipment 44 may sometimes be referred to collectively as performance metric data. In general, performance metric data may include data associated with any desired performance metric for the transmission or reception of radio-frequency signals by DUT 10′. For example, performance metric data gathered by tester 44 may include measured values of a downlink performance metric generated by DUT 10′ (e.g., measured SNR values, measured receiver sensitivity values, measured RSSI values, etc.) and/or measured values of an uplink performance metric generated by test equipment 44 (e.g., measured ACLR values, measured output power levels, etc.). Processing circuitry in test equipment 44 may process performance metric data gathered from DUT 10′ to characterize the radio-frequency performance of DUT 10′.

During radio-frequency test operations, sentinel test station 42 and production test stations 50 may gather performance metric data from DUTs 10′ for multiple radio-frequency performance metrics (e.g., to ensure adequate wireless performance of DUTs 10′ for a wide range of device operation conditions). The radio-frequency performance of DUTs 10′ may be characterized for each performance metric measured by test system 20. For example, production test station 50 may characterize a given DUT 10′ as having unacceptable radio-frequency performance for some performance metrics and having satisfactory radio-frequency performance for other performance metrics.

Production test stations 50 in test system 20 may perform pass-fail test operations on DUTs 10′. During radio-frequency test operations, DUTs 10′ that are characterized as having unacceptable radio-frequency performance for a given performance metric may be labeled as “failing” that performance metric, whereas DUTs 10′ having satisfactory radio-frequency performance for a given performance metric may be labeled as “passing” that performance metric. For example, if a given DUT 10′ has acceptable SNR performance, that device under test may be labeled as passing SNR testing. If given DUT 10′ has unacceptable ACLR performance, that device under test may be labeled as failing ACLR testing.

DUTs 10′ that exhibit satisfactory radio-frequency performance for each tested performance metric may be labeled as “passing” devices. DUTs 10′ that exhibit unacceptable radio-frequency performance for one or more radio-frequency performance metrics may be labeled as “failing” devices. Passing devices may be further assembled, tested, and/or provided to users for normal device operation. Failing devices may be discarded, calibrated, re-tested, reworked, etc.

The radio-frequency performance of DUTs 10′ for a given performance metric may be indicative of the performance of DUTs 10′ for other performance metrics. At least some performance metrics measured by test system 20 may be correlated with other performance metrics that can be measured by test system 20. The correlation between two performance metrics may, for example, be a measure of how performance metric data gathered for one performance metric varies with respect to performance metric data gathered for another performance metric. Two or more radio-frequency performance metrics that are tested by test system 20 may be so-called “well-correlated” performance metrics that vary relative to one another in a predictable and linear manner.

If a first performance metric is well-correlated with a second performance metric, measured values of the first performance metric gathered from DUTs 10′ may be used to predict the radio-frequency performance of DUTs 10′ for the second performance metric. For example, whether a given DUT 10′ passes testing for the first performance metric may be indicative of whether that device under test will pass testing for the second performance metric. In another example, measured values for the first performance metric may be used to predict the probability that a given DUT 10′ passes or fails testing for the second performance metric.

If performance metric data gathered for the first performance metric indicates that a DUT 10′ has sufficient probability of passing testing for the second performance metric, test stations 50 may omit testing on the associated DUT 10′ for the second performance metric (because, e.g., the second performance metric may not need to be tested to determine whether device 10′ has satisfactory radio-frequency performance). When performance metric data gathered for the first performance metric indicates that a DUT 10′ will have excessive probability of failing testing for the second performance metric, test stations 50 may proceed with testing the second performance metric on the associated DUT 10′. In other words, test stations 50 may skip unnecessary testing by omitting tests for performance metrics that DUTs 10′ have a sufficient probability of passing. In this way, test time may be reduced while ensuring accurate radio-frequency testing for DUTs 10′. Radio-frequency test operations during which test system 20 predicts performance metrics to be omitted from testing may sometimes be referred to as “predictive testing.”

Sentinel test station 42 may identify correlations between each performance metric to be tested prior to testing DUTs 10′ using production test stations 50. The correlation between two radio-frequency performance metrics may be described by a correlation coefficient ρ. Correlation coefficient ρ may, for example, be a measure of the linear dependence between the two performance metrics. In order to determine whether two performance metrics are well-correlated metrics, correlation coefficient ρ may be compared to a predetermined correlation threshold C. Correlation threshold C may, for example, be specified by a test system operator, design requirements, manufacturing requirements, or any other suitable requirements associated with the radio-frequency performance of DUTs 10′.

If correlation coefficient ρ exceeds correlation threshold C, the associated performance metrics may be identified as well-correlated performance metrics. If correlation coefficient ρ is less than or equal to correlation threshold C, the associated radio-frequency performance metrics may be identified as uncorrelated performance metrics. For example, a correlation threshold of 0.8 may be specified. If two performance metrics have a correlation coefficient of 0.7, the two performance metrics may be identified as uncorrelated performance metrics. If two performance metrics have a correlation coefficient of 0.9, the two performance metrics may be identified as well-correlated performance metrics. In this example, one of the well-correlated performance metrics may be used to predict the radio-frequency performance of DUTs 10′ for the other performance metric. Performance metrics that are used to predict the radio-frequency performance of DUTs 10′ for other performance metrics may sometimes be referred to herein as a predictor metrics. Performance metrics for which the radio-frequency performance of DUTs 10′ are predicted by corresponding predictor metrics may sometimes be referred to herein as dependent metrics.

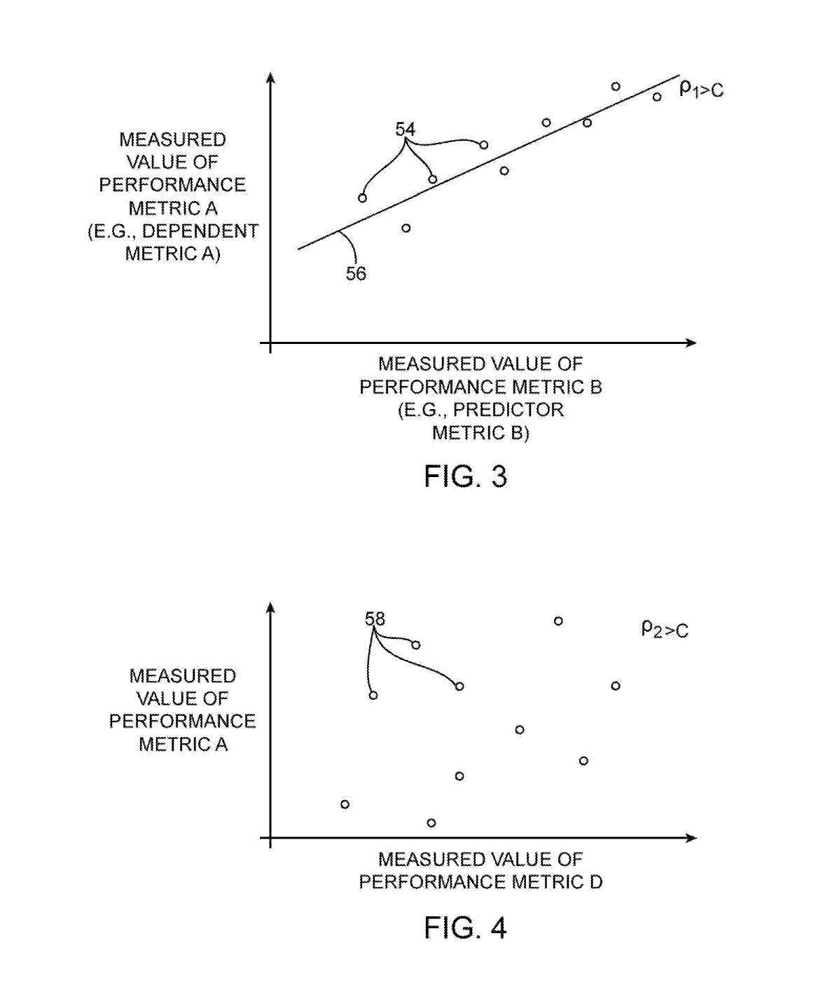

FIG. 3 is an illustrative plot showing how two radio-frequency performance metrics measured by test system 20 may be well-correlated metrics. As shown by points 54 of FIG. 3, measured values of a first performance metric B may be correlated with respect to measured values of a second performance metric A (e.g., the measured values of performance metric B may vary in an approximately linear manner with respect to the measured values of performance metric A as shown by fit line 56). Points 54 may, for example, represent measured values of performance metrics A and B gathered by sentinel test station 42 of FIG. 2 from a group of DUTs 10′.

In the example of FIG. 3, the correlation between performance metrics A and B may be described by a correlation coefficient ρ₁ that is greater than correlation threshold C. Coefficient ρ₁ may, for example, be identified by sentinel test station 42 after performing testing on a group of DUTs 10′. Performance metrics A and B may thereby by considered well-correlated performance metrics. Measured values of performance metric B may be subsequently used by production test stations 50 to predict the radio-frequency performance of DUTs 10′ for performance metric A. Performance metrics A and B may sometimes be referred to herein as dependent metric A and predictor metric B, respectively, because predictor metric B may be used to predict the radio-frequency performance of DUTs 10′ for dependent metric A.

FIG. 4 is an illustrative plot showing how two radio-frequency performance metrics measured by test system 20 may be uncorrelated metrics. As shown by points 58 of FIG. 4, measured values of a third performance metric D may vary unpredictably with respect to first performance metric A. In the example of FIG. 4, performance metrics A and D may be correlated with a correlation coefficient ρ₂ that is less than or equal to correlation threshold C. Performance metrics A and D may thereby be considered uncorrelated performance metrics.

A given performance metric may be well-correlated with some performance metrics and uncorrelated with other performance metrics measured by test system 20. In the example of FIGS. 3 and 4, performance metric A is well-correlated with performance metric B and is uncorrelated with performance metric D. Performance metric B may be used by test system 20 to predict the radio-frequency performance of DUTs 10′ for performance metric A, whereas performance metric D may be unreliable for predicting the radio-frequency performance of DUTs 10′ for performance metric A.

The examples of FIGS. 3 and 4 are merely illustrative. In general, performance metric A may be well-correlated with any number of predictor metrics (e.g., dependent metric A may be well-correlated with one predictor metric such as predictor metric B, two predictor metrics, five predictor metrics, ten predictor metrics, etc.). If desired, each predictor metric that is well-correlated with dependent metric A may be used to predict the radio-frequency performance of DUTs 10′ for dependent metric A (e.g., one or more predictor metrics that are well-correlated with an associated dependent metric may be combined to predict the radio-frequency performance of DUTs 10′ for the dependent metric).

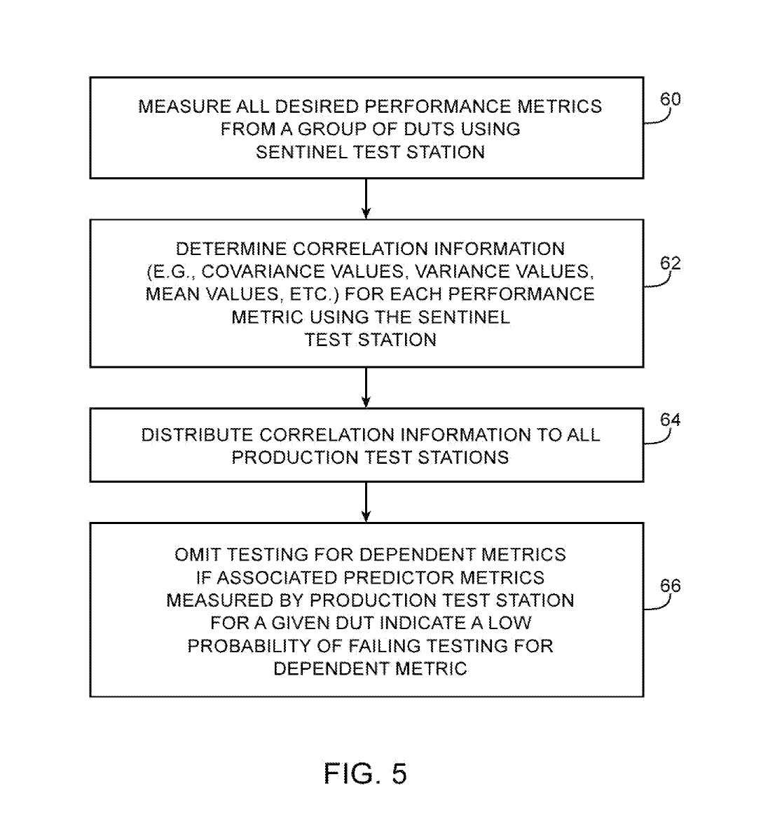

FIG. 5 shows a flow chart of illustrative steps that may be performed by a test system such as test system 20 of FIG. 2 to perform predictive radio-frequency testing for DUTs 10′. The steps of FIG. 5 may, for example, be performed by test system 20 to characterize the radio-frequency performance of DUTs 10′ while omitting testing of redundant performance metrics (e.g., performance metrics for which DUTs 10′ have a sufficient probability of passing testing).

At step 60, sentinel test station 42 may gather performance metric data from a group of DUTs 10′ for all desired performance metrics to be tested. If desired, the group of DUTs 10′ measured by sentinel test station 42 may include a sufficiently large number of DUTs 10′ to allow sentinel test station 42 to identify statistically significant correlation information for each performance metric (e.g., the group of DUTs 10′ may include more than 100 DUTs, more than 1000 DUTs, more than 10000 DUTs, etc.).

At step 62, sentinel test station 42 may identify correlation information between each of the performance metrics measured from the group of DUTs 10′ (e.g., correlation information between each respective pair of measured performance metrics). For example, sentinel test station 42 may compare the measured data for a given performance metric to measured data for each of the other measured performance metrics to determine the correlation information. Correlation information gathered by sentinel test station 42 may include statistics associated with each performance metric as gathered from all DUTs in the group of DUTs 10′. For example, sentinel test station 42 may identify a respective mean value and variance value of the measured values for each performance metric. Sentinel test station 42 may generate respective probability distributions for each measured performance metric (e.g., probability distributions that reflect the number of DUTs 10′ having a particular measured value of the associated performance metric). Sentinel test station 42 may identify correlation coefficients and covariance values between each of the measured performance metrics. The covariance values may, for example, describe how one performance metric varies with respect to another performance metric and may be a function of an associated correlation coefficient.

If desired, sentinel test station 42 may identify well-correlated performance metrics for DUTs 10′ by generating correlation coefficients ρ between each pair of the measured performance metrics (e.g., a respective correlation coefficient may be generated between each respective pair of measured performance metrics). Test station 42 may compare the correlation coefficients to respective correlation thresholds to determine which of the performance metrics are well-correlated. Sentinel test station 42 may identify a respective covariance value for each pair of measured performance metrics. If desired, sentinel test station 42 may identify predictor metrics and associated dependent metrics from the well-correlated performance metrics.

In another suitable arrangement, information about which performance metrics are predictor and dependent metrics may be externally provided to sentinel test station 42 (e.g., by a test station operator, external computing equipment coupled to sentinel test station 42, etc.). For example, performance metrics that are known to be well-correlated may be identified as predictor and dependent metrics. If desired, performance metrics for a given transmission frequency band (e.g., ACLR in a given frequency band, SNR in a given frequency band, etc.) may be identified as predictor metrics for other metrics from the same frequency band, nearby frequency bands, or overlapping frequency bands. In this way, any desired combination of performance metrics having known correlations may be identified as dependent and/or predictor metrics for predictive testing operations using test system 20.

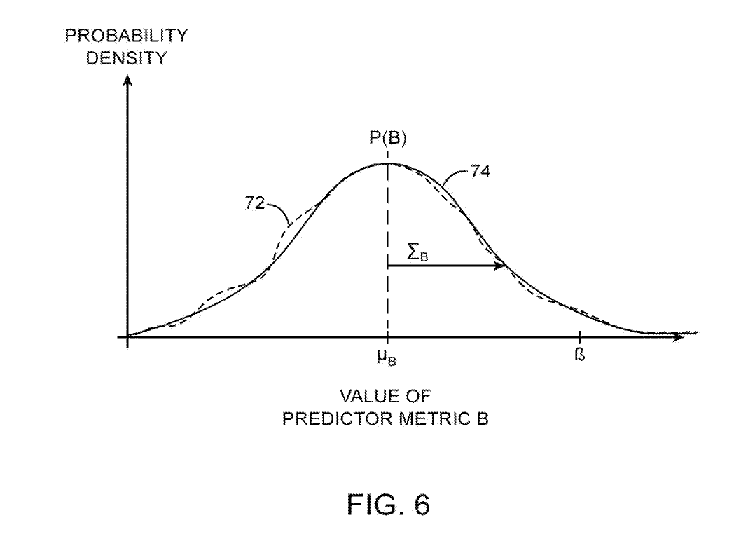

As an example, sentinel test station 42 may identify a dependent metric A and an associated predictor metric B (e.g., well-correlated metrics as shown in FIG. 3). FIG. 6 is an illustrative graph showing how sentinel test station 42 may measure different values of predictor metric B from each DUT in the group of DUTs 10′ while generating performance metric correlation information. As shown in FIG. 6, curve 72 illustrates the frequency of measured predictor metric B values gathered from the group of DUTs 10′ (e.g., curve 72 illustrates the number of DUTs 10′ from which each measured value of predictor metric B was gathered by sentinel test station 42). Sentinel test station 42 may perform a Gaussian fit of measured curve 72 to generate curve 74. Curve 74 may, for example, be a probability distribution P(B) (sometimes referred to as a probability density function) of the measured values of predictor metric B. Test station 42 may identify a mean value μ_{B} and variance value Σ_{B} associated with probability distribution 74. Curves 72 and 74 may, for example, be generated by sentinel test station 42 while processing step 62 of FIG. 5.

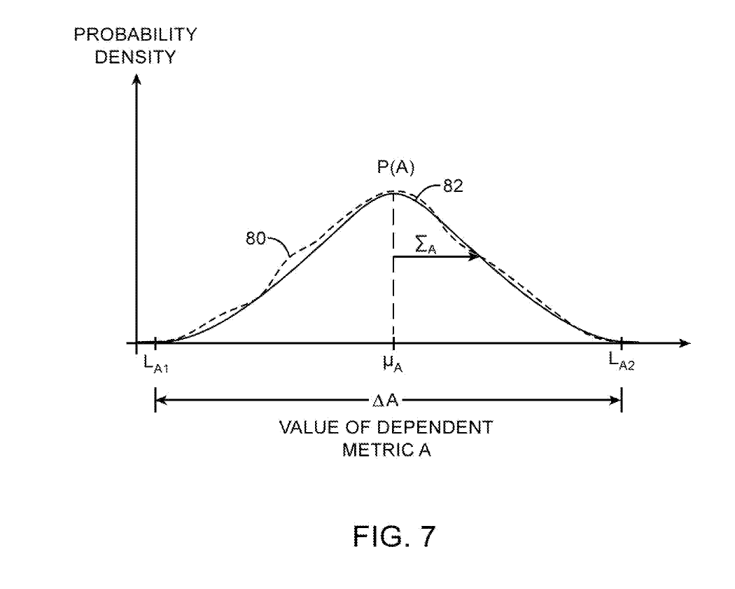

FIG. 7 is an illustrative graph showing how sentinel test station 42 may measure different values of dependent metric A from a group of DUTs 10′ while generating performance metric correlation information. As shown in FIG. 7, curve 80 illustrates the frequency of measured dependent metric A values gathered from the group of DUTs 10′. Sentinel test station 42 may perform a Gaussian fit of measured curve 80 to generate curve 82. Curve 82 may be a probability distribution P(A) of the measured values of dependent metric A. Test station 42 may identify a mean value μ_{A} and variance value Σ_{A} associated with probability distribution 82.

Correlation information generated by sentinel test station 42 may include a covariance value Σ_{AB} between dependent metric A and predictor metric B. If desired, covariance value Σ_{AB} may be a function of correlation coefficient ρ₁ between performance metrics A and B, variance value Σ_{A}, and variance value Σ_{B}. For example, covariance value Σ_{AB} may be equivalent to a product of correlation coefficient ρ₁, variance value Σ_{A}, and variance value Σ_{B} (e.g., Σ_{AB}=ρ₁*Σ_{A}*Σ_{B}).

Correlation information generated by sentinel test station 42 may include a range of acceptable values ΔA for dependent metric A (e.g., range ΔA may be a range of measured values of dependent metric A for which an associated DUT 10′ exhibits acceptable radio-frequency performance). Range ΔA may be defined by an upper limit L_{A2} and a lower limit L_{A1}. If sentinel test station 42 gathers a value of dependent metric A that is within range ΔA, the associated DUT 10′ may be considered to have satisfactory radio-frequency performance for dependent metric A (e.g., the associated DUT 10′ may be considered as “passing” dependent metric A). If sentinel test station 42 gathers a value of dependent metric A that is outside of range ΔA, the associated DUT 10′ may be considered to have unsatisfactory radio-frequency performance for dependent metric A (e.g., the associated DUT 10′ may be considered as “failing” dependent metric A).

The area under probability distribution 82 may, for example, describe the probability that DUT 10′ will have a given measured value of dependent metric A. For example, the area under curve 82 between lower limit L_{A1} and upper limit L_{A2} may represent the probability that DUT 10′ will have an acceptable measured value of dependent metric A. The area under curve 82 that is greater than upper limit L_{A2} and less than lower limit L_{A1} may represent the probability that DUT 10′ will have an unacceptable measured value of dependent metric A.

If desired, correlation information generated by sentinel test station 42 may include measured performance metric values and associated statistical values (e.g., variances values, covariance values, mean values, etc.) determined by sentinel test station 42 for each performance metric that is tested (e.g., each metric that is tested while processing step 60 of FIG. 5). In another suitable arrangement, correlation information generated by test station 42 may include measured performance metric values and associated statistical values for each dependent and predictor metrics that are identified by sentinel test station 42 (e.g., as determined while processing step 62 of FIG. 5). For example, the correlation information may include any combination of curve 74, curve 72, curve 80, curve 82, range ΔA, mean value μ_{A}, mean value μ_{B}, variance value Σ_{A}, variance value Σ_{B}, covariance value Σ_{AB}, lower limit L_{A1}, upper limit L_{A2}, correlation coefficients ρ, other information about which performance metrics are well-correlated, etc.

Referring now to step 64 of FIG. 5, sentinel test station 42 may supply the correlation information to each production test station 50 (e.g., over line 48 as shown in FIG. 2). Each production test station 50 may subsequently perform radio-frequency test operations on a respective DUT 10′ in parallel. DUTs 10′ measured by production test stations 50 may, for example, include DUTs from the group of DUTs 10′ measured by sentinel test station 42 or may include additional DUTs 10′ that are not measured by sentinel station 42.

At step 66, production test stations 50 may perform test measurements on associated DUTs 10′. Production test stations 50 may, for example, measure the predictor performance metrics for each dependent metric on the associated DUT 10′. Production test station 50 may determine the probability that the associated DUT 10′ will fail testing for the dependent performance metrics (e.g., without performing a measurement of the dependent metrics).

Production test stations 50 may use the correlation information received from sentinel test station 42 and the measured predictor metric values to determine whether the associated DUT 10′ has an unacceptably high probability of failing testing for each dependent metric. If test station 50 determines that DUT 10′ has an excessive probability of failing testing for a given dependent metric, test station 50 may subsequently perform radio-frequency testing for that dependent metric on the associated DUT 10′. If test station 50 determines that DUT 10′ has sufficient probability of passing testing for a given dependent metric, measurement of that dependent metric may be considered to be “redundant” and subsequent testing for that dependent metric may be omitted (e.g., the redundant dependent metric may be unnecessary to determine whether DUT 10′ has satisfactory radio-frequency performance).

If desired, production test stations 50 may optionally perform test operations on additional DUTs 10′ while omitting testing for previously identified redundant performance metrics. For example, a given production test station 50 may perform test operations on a set of DUTs 10′ while omitting testing for redundant performance metrics determined for a single DUT 10′. The set of DUTs 10′ may include any desired number of DUTs (e.g., one DUT 10′, two DUTs 10′, ten DUTs 10′, etc.)

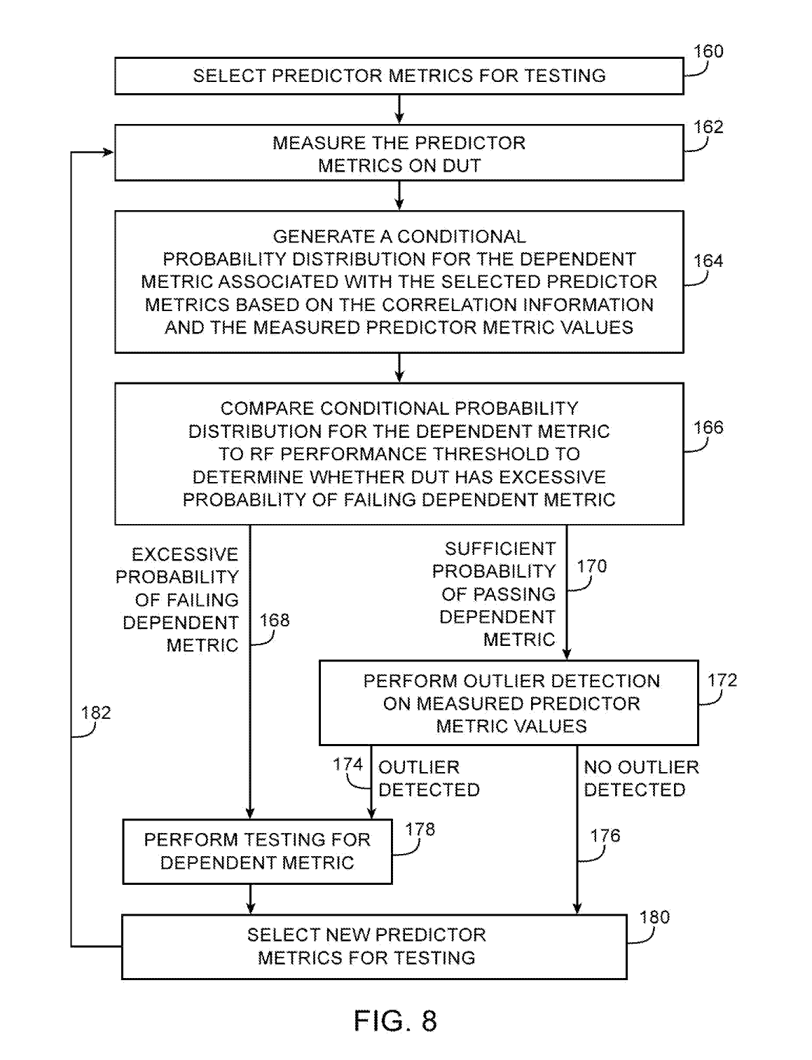

FIG. 8 shows a flow chart of illustrative steps that may be performed by a test station such as production test station 50 of FIG. 2 to perform predictive radio-frequency testing on an associated DUT 10′. The steps of FIG. 5 may, for example, be performed by each production test system 50 while processing step 66 of FIG. 5 to determine whether certain performance metrics may be omitted from subsequent testing of the associated DUT 10′.

At step 160 of FIG. 8, production test station 50 may select a set of predictor metrics for testing. The selected predictor metrics may be associated with a dependent metric (e.g., one or more predictor metrics may be associated with the dependent metric). For example, test station 50 may select predictor metric B associated with dependent metric A for testing (see, e.g., FIG. 3).

At step 162, production test station 50 may gather measured values of the selected predictor metrics from DUT 10′. For example, test station 50 may gather a measured value of predictor metric B from DUT 10′. As shown in FIG. 6, test station 50 may measure a value β of predictor metric B from the associated DUT 10′.

At step 164, production test station 50 may generate a conditional probability distribution for the dependent metric associated with the selected predictor metrics based on the correlation information and the measured values of the selected predictor metrics. For example, production test station 50 may use the covariance values for each of the selected predictor metrics and the associated dependent metric to generate a conditional probability distribution of the dependent metric that is conditional upon the measured values of the selected predictor metrics (e.g., the conditional probability distribution may be a probability distribution for the dependent metric given the previously measured values of the selected predictor metrics). The conditional probability distribution may, for example, be a multivariate normal conditional distribution (MVNCD) of the dependent metric. The MVNCD of the dependent metric may be characterized by a MVNCD mean value and MVNCD variance value.

Production test station 50 may compute the MVNCD mean and MVNCD variance values for the dependent metric using the correlation information and the measured values of the selected predictor metrics. Production test station 50 may compute the MVNCD mean value based on the mean value of the dependent metric, the mean values of the selected predictor metrics, the covariance values between the dependent metric and the selected predictor metrics, and the covariance values between each of the selected predictor metrics from the correlation information, and based on the measured values of the selected predictor metrics. For example, an MVNCD mean value μ̅ of a dependent metric may be determined using equation 1.

μ̅=μ₁+Σ₁₂Σ₂₂⁻¹(α−μ₂) (1)

In equation 1, μ₁ is the mean value of the dependent metric, μ₂ is a vector of the mean values of the selected predictor metrics, Σ₁₂ is a vector of the covariance values between the dependent metric and each of the selected predictor metrics, Σ₂₂⁻¹ is the generalized inverse of a matrix of the covariance values between each of the selected predictor metrics, and α is a vector of the measured values of each selected predictor metric (e.g., vector μ₂ may include respective mean values, vectors Σ₁₂ and Σ₂₂⁻¹ may each include respective covariance values, and vector a may include respective measured values for each of the selected predictor metrics).

Production test station 50 may compute the MVNCD variance value based on the variance value of the dependent metric, the covariance values between the dependent metric and the selected predictor metrics, and the covariance values between each of the selected predictor metrics identified in the correlation information. A MVNCD variance value Σ̅ of a dependent metric may, for example, be determined using equation 2.

Σ̅=Σ₁₁−Σ₁₂Σ₂₂⁻¹Σ₂₁ (2)

In equation 2, Σ₁₁ is the variance of the dependent metric and Σ₂₁ is the transpose of covariance vector Σ₁₂.

As an example, production test station 50 may generate a conditional probability distribution for dependent metric A after gathering measured value β of predictor metric B from DUT 10′. Test station 50 may generate a multivariate normal conditional distribution for dependent metric A that is conditional upon measured predictor metric value β and the correlation information for dependent metric A and predictor metric B. Test station 50 may compute the MVNCD mean for dependent metric A based on mean value μ_{A}, mean value μ_{B}, measured value β, and covariance value Σ_{AB} between predictor metric A and dependent metric B. For example, an MVNCD mean value μ̅_{A} of dependent metric A may be determined using equation 3.

μ̅_{A}=μ_{A}+Σ_{AB}(β−μ_{B}) (3)

Equation 3 may, for example, be obtained by substituting mean value μ_{A}, mean value μ_{B}, covariance value Σ_{AB}, and measured dependent metric value β into equation 1. In this example, the covariance value between each predictor metric is equal to one, because only one predictor metric B is used.

Test station 50 may compute the MVNCD variance value based on variance value Σ_{A} and covariance value Σ_{AB} in the correlation information received from sentinel test station 42. An MVNCD variance value Σ̅_{A} of dependent variable A may, for example, be determined using equation 4.

Σ̅_{A}=Σ_{A}−Σ_{AB}² (4)

Equation 4 may, for example, be obtained by substituting variance value Σ_{A} and covariance value Σ_{AB} into equation 2. In this example, the transpose of covariance value Σ_{AB} is equal to Σ_{AB} because only one predictor metric B is used (e.g., Σ_{AB} is a one-dimensional vector). The MVNCD generated for dependent metric A may be a conditional probability distribution P(A|B) that is conditional upon measured value β of predictor metric B and the correlation information (e.g., MVNCD P(A|B) may represent the probability that a given value of dependent metric A would be subsequently gathered by test system 50 given that test station 50 previously measured predictor metric value β).

At step 166, test station 50 may analyze the conditional probability distribution generated for the dependent metric to determine whether DUT 10′ is likely to fail testing for the dependent metric. A range of acceptable values having a lower limit and an upper limit may be applied to the MVNCD generated for the dependent metric (e.g., a range of acceptable values over which DUT 10′ may be characterized as having satisfactory radio-frequency performance for the dependent metric). The area under the MVNCD for the dependent metric that is outside of the range of acceptable values (e.g., the area under the MVNCD corresponding to a value greater than the upper limit or less than the lower limit) may be compared to a radio-frequency threshold (sometimes referred to herein as an area threshold) to determine whether to skip testing for the dependent metric. The area threshold may, for example, be specified by a test system operator, design requirements, manufacturing requirements, or any other suitable requirements associated with the radio-frequency performance of DUTs 10′. If the area under the MVNCD that is outside of the range of acceptable values is greater than the area threshold, test station 50 may determine that there is excessive probability that DUT 10′ will fail testing for the dependent metric and processing may proceed to step 178 via path 168.

At step 178, production test station 50 may perform radio-frequency test operations on DUT 10′ for the dependent metric (e.g., production test station 50 may perform pass-fail testing on DUT 10′ for the dependent metric). In this way, production test station 50 may ensure that accurate testing is performed on DUT 10′ for performance metrics that DUT 10′ has a relatively high probability of failing.

At step 180, production test station 50 may select new predictor metrics for testing. The new predictor metrics may include, for example, some or all of the previously measured predictor metrics, the previous dependent metric, or any other predictor metrics that are associated with a dependent metric. Processing may subsequently loop back to step 162 via path 182 to determine whether to omit testing for a dependent metric associated with the new predictor metrics.

If the area under the MVNCD outside of the range of acceptable values for the dependent metric is less than the area threshold, test station 50 may proceed to step 172 via path 170. At step 172, production test station 50 may perform outlier detection operations on the measured predictor metrics to determine whether any anomalous (e.g., excessively large) predictor metric values were gathered. For example, test station 50 may compare the measured predictor metric values to respective outlier thresholds (e.g., different outlier thresholds may be used for different predictor metrics or the same outlier thresholds may be used). The outlier thresholds may include upper and lower outlier thresholds. If one of the measured predictor metric values is greater than the associated upper outlier threshold or less than the associated lower outlier threshold, test system 50 may determine that an outlier has been detected. Measurement of an outlier predictor metric value may indicate an increased likelihood that DUT 10′ will fail testing for the associated dependent metric, may indicate an unreliable computation of the conditional probability distribution, and/or may indicate the presence of a test error at production test station 50.

If production test station 50 detects an outlier in the selected predictor metric values, processing may proceed to step 178 via path 174 to perform radio-frequency test operations on DUT 10′ for the associated dependent metric (e.g., test station 50 may perform testing for the dependent metric to ensure accurate testing for DUT 10′ after an anomalous predictor metric value has been measured). If production test station 50 does not detect an outlier predictor metric value, the associated dependent metric may be labeled a redundant (unnecessary) performance metric and testing for that dependent metric may be omitted during testing of DUT 10′. Processing may subsequently proceed to step 180 via path 176 to select new predictor metrics for testing.

FIG. 8 is merely illustrative. If desired, production test station 50 may decide whether to skip testing for the dependent metric without performing outlier detection (e.g., step 172 may be omitted from processing). If desired, step 172 may be performed prior to generating the conditional probability distribution for the dependent metric (e.g., step 172 may be performed prior to processing step 164 of FIG. 8).

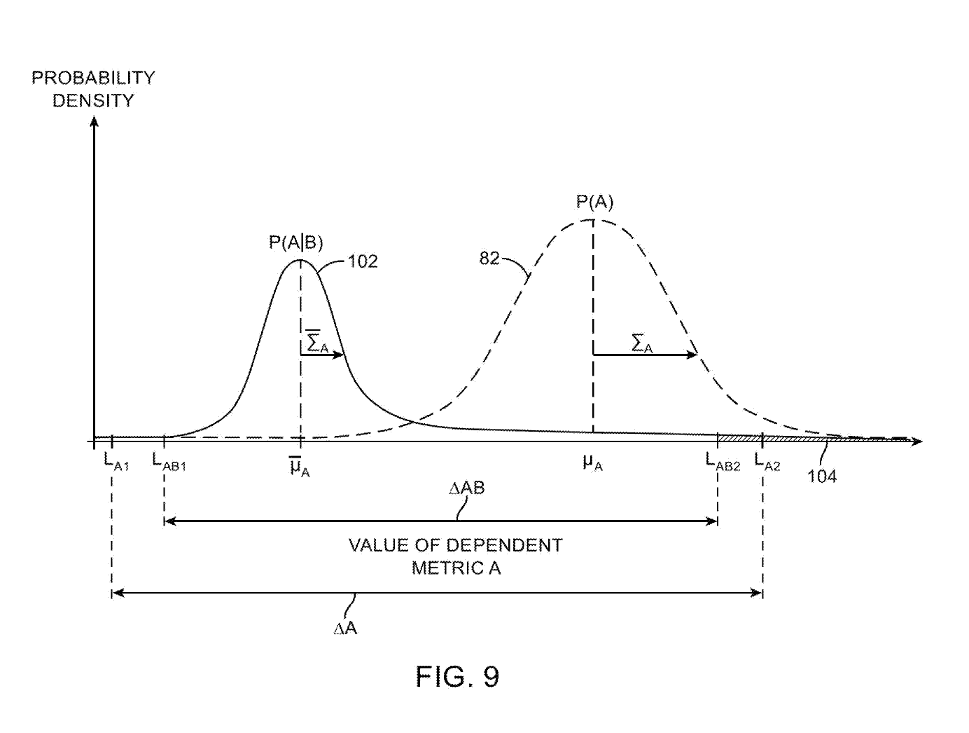

FIG. 9 is an illustrative graph showing how a multivariate normal conditional distribution generated for dependent metric A may be used to determine whether to DUT 10′ has excessive probability of failing testing for dependent metric A (e.g., dependent metric A associated with predictor metric B as shown in FIGS. 3, 6 and 7). As shown in FIG. 9, curve 102 illustrates multivariate normal conditional distribution P(A|B) for dependent metric A given the correlation information and measured predictor metric value β. Probability distribution 102 may, for example, be generated by production test station 50 while processing step 164 of FIG. 8 for dependent metric A and predictor metric B. Distribution 102 may be characterized by MVNCD mean value μ̅_{A} and MVNCD variance value Σ̅_{A} (e.g., as determined using equations 3 and 4). Curve 82 illustrates the probability distribution of dependent metric A in the correlation information (e.g., as shown by curve 82 of FIG. 7).

In the example of FIG. 9, test station 50 may impose a range of acceptable values ΔAB for MVNCD 102 (e.g., a range defined by lower limit L_{AB1} and upper limit L_{AB2}). Limit range ΔAB may be any desired range of acceptable values for dependent metric A that is less than or equal to limit range ΔA associated with curve 82 (FIG. 7). Test station 50 may compare the area under MVNCD 102 that is outside of range ΔAB to a predetermined area threshold to determine whether to skip testing for dependent variable A. If desired, the area under MVNCD 102 that is greater than upper limit L_{AB2}, lower than lower limit L_{AB1}, or both lower than lower limit L_{AB1} and greater than upper limit L_{AB2} may compared to the area threshold to determine whether to skip testing for performance metric A.

In the example of FIG. 9, area 104 that is greater than upper limit L_{AB2} may be compared to the predetermined area threshold. If area 104 is greater than the area threshold, test station 50 may perform testing for performance metric A (e.g., test station 50 may process step 178 of FIG. 8). If area 104 is less than or equal to the area threshold, test station 50 may omit testing of performance metric A on the associated DUT 10′ assuming measured predictor metric value β is not an outlier (e.g., assuming that measured predictor metric value β is less than an associated upper outlier threshold and greater than an associated lower outlier threshold).

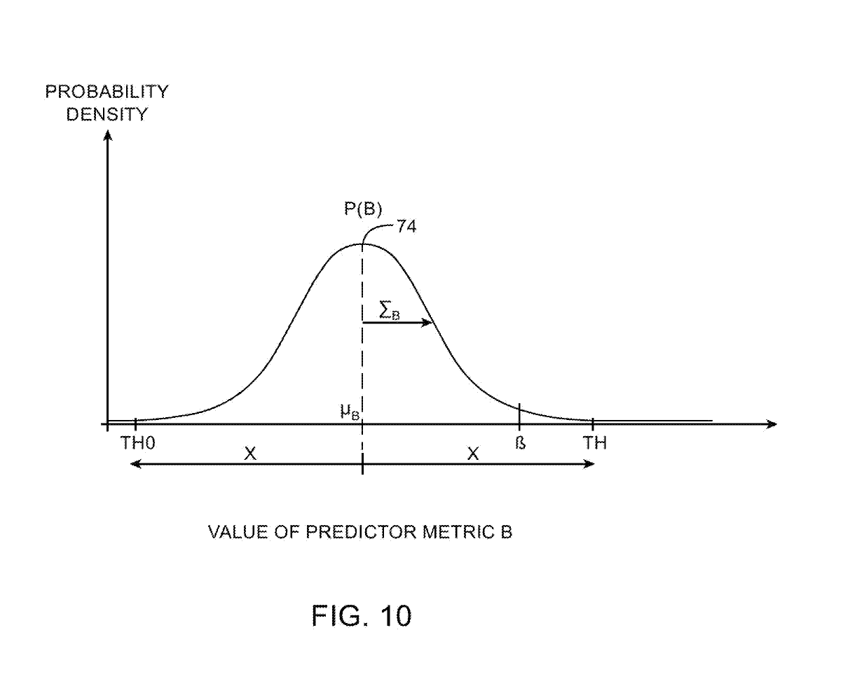

FIG. 10 is an illustrative graph showing how a measured value of predictor metric B may be compared to outlier thresholds during outlier detection operations (e.g., while production test station 50 processes step 172 of FIG. 8). As shown by FIG. 9, curve 74 illustrates the probability distribution for predictor metric B as determined by sentinel test station 42 while generating correlation information for a group of DUTs 10′ (e.g., as shown in FIG. 6).

Production test station 50 may impose an upper outlier threshold TH and a lower outlier threshold TH0 for the measured value of predictor metric B. Outlier thresholds TH0 and TH may be selected so that a desired percentage of the area under probability distribution 74 is associated with a predictor metric B value that is less than threshold TH and greater than threshold TH0. For example, outlier thresholds TH and TH0 may be selected so that 99.5% of the area under curve 74 has a predictor metric B value that is less than threshold TH and greater than threshold TH0, 99.95% of the area under curve 74 has a predictor metric B value that is less than threshold TH and greater than threshold TH0, etc. In another suitable arrangement, outlier thresholds TH0 and TH may be selected so that outlier thresholds TH0 and TH are within a variance range X of mean value μ_{B}. Variance range X may, for example, be equivalent to a multiple of the standard deviation of predictor metric B. The standard deviation of predictor metric B may be calculated as the square root of variance value Σ_{B} of predictor metric B. For example, variance range X may be equivalent to 2*SQRT(Σ_{B}), 1.5*SQRT(Σ_{B}), 3*SQRT(Σ_{B}), or any other desired value, where SQRT(Σ_{B}) is the square root of variance value Σ_{B} of predictor metric B. Production test station 50 may compare a measured predictor metric value β to outlier thresholds TH0 and TH.

In the example of FIG. 10, measured predictor metric value β is less than upper outlier threshold TH and greater than lower outlier threshold TH (e.g., predictor metric value β is within variance range X of mean value μ_{B}) and subsequent testing on DUT 10′ for dependent metric A may be omitted. If production test station 50 measures a predictor metric value that is greater than upper outlier threshold TH or less than lower outlier threshold TH0, that measured predictor value may be labeled an outlier value and testing for dependent metric A may be performed.

Any desired performance metric for characterizing the radio-frequency performance of DUTs 10′ may be measured by test system 20 during predictive test operations. As an example, test system 20 may measure performance metrics associated with radio-frequency signals transmitted by DUTs 10′ such as adjacent channel leakage ratio (ACLR). ACLR is a measure of how well adjacent frequency channels over which DUTs 10′ transmit signals are isolated from each other. When adjacent channels are well isolated from each other, ACLR values gathered by test equipment will be low (e.g., less than −33 dBc or even lower). When signals from one frequency channel spill over into an adjacent channel, gathered ACLR values will be high (e.g., more than −33 dBc). High ACLR values may characterize unsatisfactory radio-frequency performance for DUT 10′, whereas low ACLR values may characterize satisfactory performance.

DUT 10′ may be configured to transmit radio-frequency signals at multiple transmit frequencies. ACLR values gathered from DUT 10′ for signals transmitted at one frequency may be well-correlated with ACLR values gathered from DUT 10′ for signals transmitted at another frequency. For example, ACLR for a first transmit frequency may be a predictor metric that is associated with ACLR for a second transmit frequency (e.g., production test stations 50 may use ACLR values for the first frequency to predict whether DUT 10′ will fail testing for ACLR at the second frequency). In this example, measurement of ACLR at the first frequency may be used to decide whether to omit testing for ACLR at the second frequency.

A graph showing how DUT 10′ may have different levels of adjacent channel power leakage for signals transmitted at different frequencies is shown in FIG. 9. As shown in FIG. 9, curve 106 illustrates the output power of a DUT 10′ over a range of transmit frequencies. Curve 106 may, for example, be measured by sentinel test station 42 (e.g., while processing step 60 of FIG. 5). DUT 10′ may transmit uplink signals at output power level P_{MAX1} at frequency F₁ and may transmit uplink signals at output power level P_{MAX2} at second frequency F₂. Signals transmitted by DUT 10′ at frequency F₁ may leak over onto adjacent frequency F₁′ at output power level P₂. An ACLR value ACLR1 associated with the first frequency channel may be given by the ratio of power level P₁ to power level P_{MAX1} (e.g., ACLR1=P₁/P_{MAX1}). Signals transmitted by DUT 10′ at frequency F₂ may leak over onto adjacent frequency F₂′ with power level P₂. An ACLR value ACLR2 associated with the second frequency channel may be given by the ratio of power level P₂ to power level P_{MAX2} (e.g., ACLR2=P₂/P_{MAX2}).

ACLR at the first frequency may be a predictor metric for ACLR at the second frequency (e.g., ACLR at the second frequency may be the dependent metric associated with ACLR at the first frequency). Sentinel test station 42 may generate correlation information from a group of DUTs 10′ for ACLR values at frequencies F₁ and F₂. For example, curve 74 of FIG. 6 may be a probability distribution of ACLR values at frequency F₁ and curve 82 of FIG. 7 may be a probability distribution of ACLR values at frequency F₂. A production test station 50 may subsequently measure an ACLR value at frequency F₁ from a DUT 10′ and may generate an MVNCD for ACLR at frequency F₂ based on the correlation information and the measured ACLR value at frequency F₁ (e.g., while processing step 164 of FIG. 8). For example, curve 102 of FIG. 9 may be a multivariate normal conditional distribution for ACLR values at frequency F₂ given the correlation information and the ACLR value at frequency F₁ gathered by production test station 50. Test station 50 may compare the MVNCD for ACLR at frequency F₂ to radio-frequency performance thresholds to determine whether to omit measurement of ACLR at frequency F₂ on the associated DUT 10′.

The example of FIGS. 6-10 in which sentinel test station 42 identifies dependent metrics and associated predictor metrics is merely illustrative. If desired, production test station 50 may perform testing for all performance metrics measured by sentinel test station 42 (e.g., test stations 42 may measure any desired combination of performance metrics that characterize the radio-frequency performance of DUTs 10′ to determine which performance metrics are redundant).

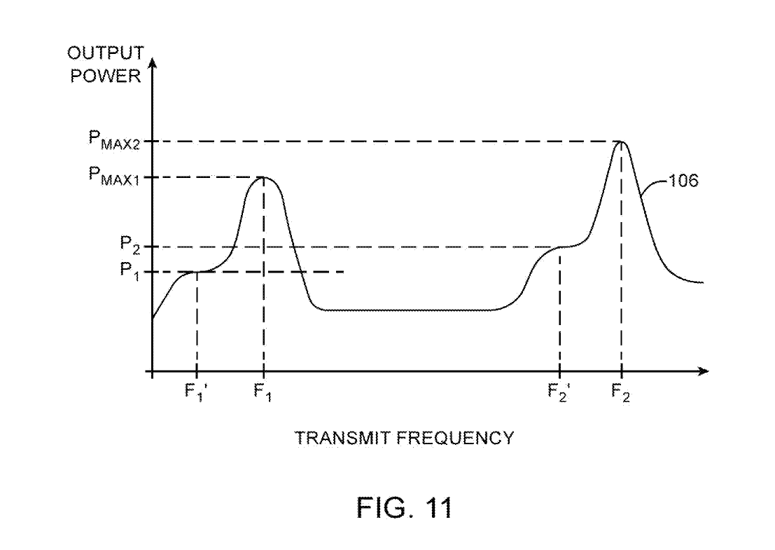

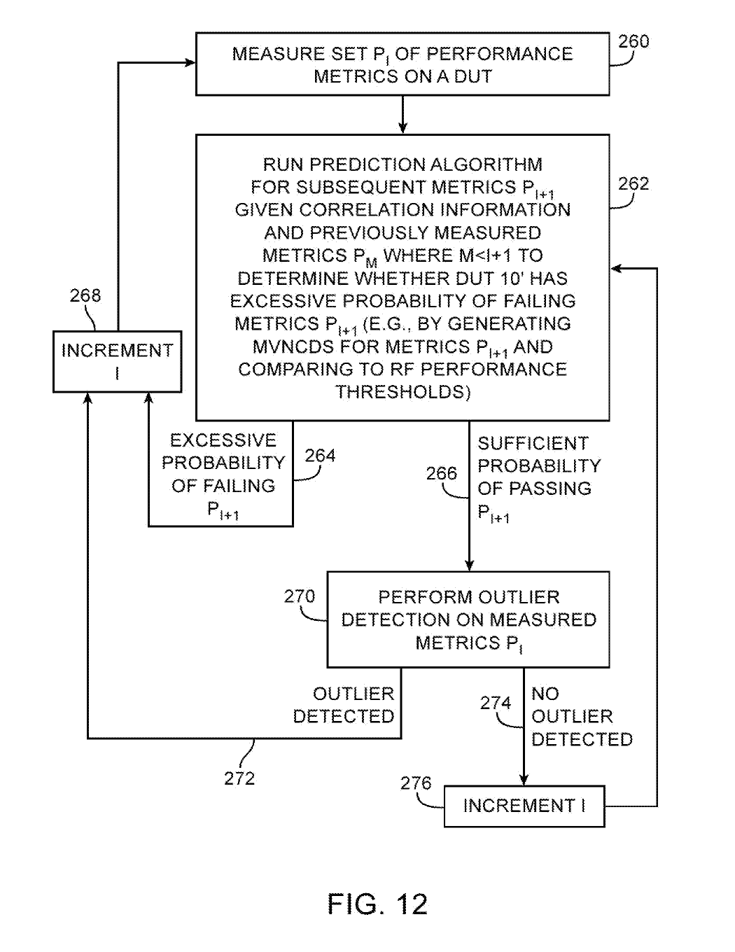

FIG. 12 shows a flow chart of illustrative steps that may be performed by a test station such as a production test station 50 of FIG. 2 to perform predictive radio-frequency testing on a DUT 10′ for all performance metrics measured by sentinel test station 42 (e.g., without identifying predictor and dependent metrics using sentinel test station 42). The steps of FIG. 11 may, for example, be performed by test station 50 after receiving correlation information from sentinel test station 42 for each measured performance metric. Testing each performance metric using production test station 50 without previously identifying predictor and dependent metrics for testing may sometimes be referred to herein as “causal” predictive testing.

At step 260, production test station 50 may measure a first set of performance metrics P_{I} on an associated DUT 10′. The set of performance metrics P_{I} may include any desired number of performance metrics from the performance metrics measured by sentinel test station 42. For example, set P_{I} may include one performance metric, two performance metrics, ten performance metrics, etc.

At step 262, production test station 50 may generate a conditional probability distribution for a subsequent set of performance metrics P_{I+1} (e.g., set P_{I+1} may include any desired number of performance metrics). For example, test station 50 may generate a multivariate normal conditional distribution for each performance metric in set P_{I+1} using the correlation information received from sentinel test station 42 and the measured values of performance metrics P_{I}. In this example, the performance metrics of set P_{I} may serve as predictor metrics and the performance metrics of set P_{I+1} may serve as dependent metrics when calculating the associated MVNCD mean and variance values for each metric of set P_{I+1} using equations 1 and 2 (e.g., the MVNCD mean and variance values may be computed regardless of whether the metrics of sets P_{I} and P_{I+1} are well-correlated). If set P_{I+1} includes more than one performance metric, production test station 50 may generate a respective multivariate normal conditional distribution for each of the performance metrics in set P_{I+1}.

Production test station 50 may compare each MVNCD generated for the performance metrics of set P_{I+1} to associated radio-frequency thresholds. For example, test station 50 may compare each MVNCD to a respective area threshold to determine whether DUT 10′ has excessive probability of failing testing for the performance metrics in set P_{I+1}. If test station 50 determines that DUT 10′ has excessive probability of failing testing for one or more performance metrics in set P_{I+1}, processing may proceed to step 268 via path 264. At step 268, production test station 50 may increment index I. Processing may subsequently loop back to step 260 to measure the performance metrics in set P_{I+1}.

If test station 50 determines that DUT 10′ has a sufficient probability of passing testing for each of the performance metrics in set P_{I+1}, processing may proceed to step 270 via path 266. At step 270, test station 50 may perform outlier detection on the measured values of performance metrics in set P_{I} (e.g., as described in connection with step 172 of FIG. 8).

If test station 50 detects an outlier in the measured values of the performance metrics in set P_{I}, processing may proceed to step 268 via path 272. At step 268, test station 50 may increment index I. Processing may loop back to step 260 to measure performance metric P_{I+1} on DUT 10′.

If test station 50 determines that there are no outlier values in the measured values of metrics P_{I}, test station 50 may omit testing for metrics P_{I+1} and processing may proceed to step 276 via path 274. At step 274, test station 50 may increment index I. Processing may loop back to step 262 to determine whether to omit testing for a subsequent set of performance metrics (e.g., production test station 50 may generate an MVNCD for a subsequent set of performance metrics given performance metric set P_{I}).

If desired, the order of performance metrics that are measured by test station 50 may be selected using known relationships between each of the performance metrics such as whether a given performance metric is likely to be a predictor or dependent performance metric. For example, the order of performance metrics to be measured may be selected so that production test stations 50 perform tests for performance metrics that are likely to be predictor metrics prior to tests for performance metrics that are likely to be dependent performance metrics. Production test station 50 may thereby reduce unnecessary test time while testing DUTs 10′.

In another suitable arrangement, each production test station 50 in test system 20 may periodically generate correlation information (e.g., each production test station 50 may temporarily serve as a sentinel test station). For example, correlation information may be gathered from a group of DUTs 10′ by a first production test station for a first period of time, correlation information may be gathered from a group of DUTs 10′ by a second production test station for a second period of time, etc. In this scenario, sentinel test station 42 may generate a first set of correlation information for use by production test stations 50 and may monitor test system 20 to ensure that all production test stations 50 are operating properly. In this way, the effect of test station manufacturing variations on the test results may be reduced.

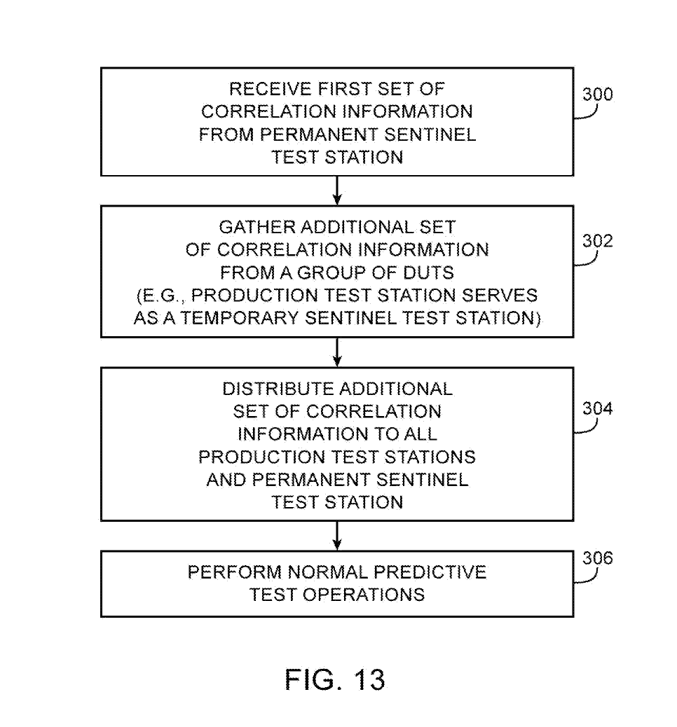

FIG. 13 shows a flow chart of illustrative steps that may be performed by a production test station such as production test station 50 of FIG. 2 to temporarily gather correlation information from a group of DUTs 10′. The steps of FIG. 13 may, for example, be performed by test station 50 after a permanent sentinel test station 42 in test system 20 gathers a first set of correlation information from a group of DUTs 10′.

At step 300, production test station 50 may receive the first set of correlation information from permanent sentinel test station 42.

At step 302, production test station 50 may gather an additional set of correlation information from a group of DUTs 10′ (e.g., production test station 50 may serve as a temporary sentinel test station for test system 20). Other production test stations in system 20 may perform normal predictive testing operations using the first set of correlation information (e.g., by processing the steps of FIG. 8) while the second set of correlation information is being generated by production test station 50.

At step 304, production test station 50 may distribute the second set of correlation information to permanent sentinel test station 42 and all other production test stations in test system 20. Each production test station in system 20 may subsequently use the second set of correlation information to determine which performance metrics may be omitted from testing.

At step 306, production test system 50 may resume normal predictive testing operations (e.g., by processing the steps of FIG. 8). Additional production test stations in system 20 may subsequently generate additional sets of correlation information for system 20. Production test system 50 may receive the additional sets of correlation information and may determine which performance metrics to omit during testing based on the additional sets of correlation information.

Permanent sentinel test station 42 may continuously monitor each production test station 50 in system 20. For example, sentinel test station 42 may compare each set of correlation information generated by a production test stations 50 to the first set of correlation information. If a set of correlation information generated by a production test station varies excessively with respect to the first set of correlation information, permanent sentinel test station 42 may, for example, instruct all test stations 50 to measure all performance metrics (e.g., predictive testing may be temporarily turned off).

If desired, permanent sentinel test station 42 may retrieve failure rate information from each production test station 50 in system 20 (e.g., failure rate information such as the percentage of DUTs 10′ that are labeled as failing DUTs' by a given production test station 50 may be gathered by sentinel test station 42). Sentinel test station 42 may compare the failure rate information from each production test station 50 to a corresponding failure rate threshold. If a given production test station 50 has an excessive failure rate (i.e., a failure rate that exceeds the failure rate threshold), the associated production test station 50 may be switched off, provided with a new set of correlation information, calibrated, flagged for analysis, etc.

If desired, sentinel test station 42 may perform radio-frequency testing on the group of DUTs 10′ being tested by production test station 50 (e.g., after sentinel test station 42 has finished generating the correlation information). In this scenario, sentinel test station 42 may perform radio-frequency testing for all performance metrics (e.g., for all performance metrics for which the correlation information was generated without omitting testing for any performance metrics).

If sentinel test station 42 measures a test failure rate that excessively varies with respect to test failure rates of production test stations 50, sentinel test station 42 may instruct production test stations 50 to no longer omit testing for selected, previously-omitted performance metrics. Once new training data representative of the performance of DUTs 10′ currently under test by production test station 50 is generated, sentinel test station 42 may subsequently instruct production test stations 42 to resume omission of the previously-omitted performance metrics.

The foregoing is merely illustrative of the principles of this invention and various modifications can be made by those skilled in the art without departing from the scope and spirit of the invention. The foregoing embodiments may be implemented individually or in any combination.

What is claimed is:

1. A method of using a test system to perform pass-fail tests on devices under test to determine whether the devices under test perform satisfactorily, the method comprising:
with the test system, evaluating device performance for the devices under test by measuring a plurality of performance metrics for the devices under test; and
with the test system, analyzing the plurality of performance metrics for the devices under test to predict which of the performance metrics are redundant for performing the pass-fail tests by determining which of the performance metrics exhibit probabilities of failure that are less than a predetermined threshold.

2. The method defined in claim 1, wherein the devices under test comprise electronic devices under test having wireless communications circuitry, wherein the plurality of performance metrics comprise wireless performance metrics associated with radio-frequency performance of the wireless communications circuitry, and wherein measuring the plurality of performance metrics for the devices under test comprises:
measuring the plurality of wireless performance metrics for each of the electronic devices under test.

3. The method defined in claim 1, wherein analyzing the plurality of performance metrics for the devices under test comprises:
identifying correlation information for each respective pair of performance metrics in the plurality of performance metrics.

4. The method defined in claim 3, wherein identifying the correlation information comprises:
identifying a respective covariance value for each pair of performance metrics in the plurality of performance metrics.

5. The method defined in claim 3, wherein analyzing the plurality of performance metrics for the devices under test further comprises:
generating a conditional distribution for a selected performance metric in the plurality of performance metrics based at least partly on the identified correlation information.

6. The method defined in claim 1, wherein analyzing the plurality of performance metrics for the devices under test comprises:
generating a respective probability distribution for each performance metric in the plurality of performance metrics.

7. The method defined in claim 6, wherein analyzing the plurality of performance metrics for the devices under test further comprises:
identifying respective mean values and variance values of the probability distributions for each performance metric in the plurality of performance metrics.

8. The method defined in claim 1, further comprising:
with the test system, evaluating device performance for the devices under test without measuring the redundant performance metrics.

9. A method of performing pass-fail testing on a plurality of wireless electronic devices under test using a test system having at least first and second test stations, the method comprising:
with the first test station, gathering performance metric data from the plurality of wireless electronic devices under test by measuring a plurality of radio-frequency performance metrics for each wireless electronic device under test in the plurality of wireless electronic devices under test;
with the second test station, gathering measurement data by measuring a subset of the plurality of radio-frequency performance metrics for a selected wireless electronic device under test; and
with the second test station, determining whether to omit testing of a dependent radio-frequency performance metric in the plurality of radio-frequency performance metrics for the selected wireless electronic device under test based on the gathered measurement data and the gathered performance metric data.

10. The method defined in claim 9, wherein the performance metric data comprises correlation information associated with each respective pair of radio-frequency performance metrics in the plurality of radio-frequency performance metrics and wherein determining whether to omit testing for the dependent radio-frequency performance metrics comprises:
determining whether to omit testing for the dependent radio-frequency performance metric based on the gathered measurement data and the correlation information.

11. The method defined in claim 10, further comprising:
determining whether to omit testing on the wireless electronic device under test for an additional dependent radio-frequency performance metric of the plurality of radio-frequency performance metrics based on the gathered measurement data and the correlation information.

12. The method defined in claim 10, wherein determining whether to omit testing for the dependent radio-frequency performance metric comprises:
computing a probability that the selected wireless electronic device under test will fail testing for the dependent radio-frequency performance metric.

13. The method defined in claim 12, wherein computing the probability that the selected wireless electronic device under test will fail testing for the dependent radio-frequency performance metric comprises:
generating a conditional probability distribution for the dependent radio-frequency performance metric based on the gathered measurement data and the correlation information.

14. The method defined in claim 13, wherein determining whether to omit testing for the dependent radio-frequency performance metric further comprises:
comparing an area under the conditional probability distribution for the dependent radio-frequency performance metric to a predetermined threshold.

15. The method defined in claim 14, wherein determining whether to omit testing for the dependent radio-frequency performance metric further comprises:
in response to determining that the area under the conditional probability distribution for the dependent radio-frequency performance metric is less than the predetermined threshold, comparing the gathered measurement data to upper and lower outlier thresholds.

16. The method defined in claim 15, wherein determining whether to omit testing for the dependent radio-frequency performance metric further comprises:
in response to determining that the gathered measurement data is less than the upper outlier threshold and greater than the lower outlier threshold, omitting testing for the dependent radio-frequency performance metric.

17. The method defined in claim 13, wherein generating the conditional probability distribution for the dependent radio-frequency performance metric comprises:
generating a multivariate normal conditional distribution for the dependent radio-frequency performance metric based on the gathered measurement data and the correlation information.

18. The method defined in claim 17, wherein the correlation information comprises a respective mean value, variance value, and covariance value associated with each radio-frequency performance metric in the subset of radio-frequency performance metrics and wherein generating the multivariate normal conditional distribution comprises:
generating the multivariate normal conditional distribution for the dependent radio-frequency performance metric based on the gathered measurement data, the respective mean value, variance value, and covariance value associated with each radio-frequency performance metric in the subset of radio-frequency performance metrics.

19. A method of using a test system having at least first and second test stations to perform radio-frequency testing on a group of electronic devices under test, the method comprising:
with the first test station, measuring a plurality of performance metrics on the group of electronic devices under test;
with the first test station, obtaining correlation information that identifies a predictor performance metric and a dependent performance metric in the plurality of performance metrics, wherein the dependent performance metric correlates with the predictor performance metric;
with the second test station, gathering measurement data from a selected electronic device under test for the identified predictor performance metric; and
with the second test station, determining whether to skip testing of the dependent performance metric for the selected electronic device under test based on the correlation information and the gathered measurement data.

20. The method defined in claim 19, wherein obtaining the correlation information comprises:
identifying a respective correlation coefficient between each respective pair of performance metrics in the plurality of performance metrics;
comparing each correlation coefficient to a predetermined threshold; and
in response to determining that the correlation coefficient for a particular pair of performance metrics in the plurality of performance metrics is greater than the predetermined threshold, identifying that pair of performance metrics as a well-correlated pair of performance metrics.

21. The method defined in claim 20, wherein the well-correlated pair of performance metrics includes first and second performance metrics and wherein identifying the correlation information further comprises:
identifying the first performance metric as the predictor performance metric and the second performance metric as the dependent performance metric.

22. The method defined in claim 19, wherein determining whether to skip testing for the dependent performance metric comprises:
generating a conditional probability distribution for the dependent performance metric based on the gathered measurement data and the correlation information; and
comparing an area under the conditional probability distribution to a predetermined area threshold.

23. The method defined in claim 22, wherein determining whether to skip testing for the dependent performance metric further comprises:
in response to determining that the area under the conditional probability distribution is greater than the predetermined area threshold, performing testing of the dependent performance metric for the selected electronic device under test.

24. The method defined in claim 22, wherein determining whether to skip testing for the dependent performance metric further comprises:
in response to determining that the area under the conditional probability distribution less than the predetermined area threshold, skipping testing of the dependent performance metric for the selected electronic device under test.
